(19) United States
(12) Patent Application Publication
(10) Pub. No.: US 2019/0383408 A1
(43) Pub. Date: Dec. 19, 2019

(54) AIR VALVE FOR OPENING OF COMPRESSION BAG

(71) Applicant: Yuyao Huayin Packing Material Co., Ltd., Yuyao City (CN)

(72) Inventor: Weixin XU, Yuyao City (CN)

(21) Appl. No.: 16/144,440

(22) Filed: Sep. 27, 2018

(30) Foreign Application Priority Data
Jun. 15, 2018 (CN) 201820931595.6

(51) Int. Cl. F16K 15/20; F16K 24/04; B65D 81/20

(52) U.S. Cl. CPC F16K 15/205; B65D 2205/02; B65D 81/2038; F16K 24/04

(57) ABSTRACT

The utility model provides an air valve for an opening of a compression bag. An air valve bottom plate is provided with a cylinder. The air valve bottom plate and the cylinder are penetrated through an air vent. The air vent is provided with a ring sleeve, and a silicon pad fits a convex ring of the ring sleeve. The air vent is provided with support ribs. A lower opening of the air vent is provided with ribs. The ribs and the support ribs are all disposed on the air valve bottom plate. A ring is disposed at a central position of the air vent, and the support ribs are connected to the ring. A longitudinal portion of the silicon pad passes through the ring, and the silicon pad is provided with a boss. The utility model has a simple and reliable structure and a desirable effect in use.

### TECHNICAL FIELD

The utility model relates to the field of valve structure technologies for compression bags, and in particular, to an air valve for an opening of a compression bag.

### BACKGROUND ART

At present, people pay much attention to saving storage space. There are a lot of thick quilts and clothes in normal families, and the problem of a large storage space occupied has been bothering people. Especially in the areas with the plum rain season, mouldproof and moistureproof functions are crucial. The emergence of vacuum compression bags with waterproof, mouldproof, moistureproof, and other protection functions and even a space-saving function solves many problems for people, and such bags are widely applied now.

There are various vacuum compression bag products available on the market. Air valves for the vacuum compression bags are increasingly advanced, and generally can be used in combination with a vacuum cleaner (a household vacuum cleaner), thus bringing a lot of conveniences for people in use. A screw-type air valve is generally used as an air valve of a vacuum compression bag. In the prior art, the screw-type air valve has excessive components and a complex structure. Therefore, machining and assembling processes are rather complicated. The air displacement during venting is rather small and the sealing performance is rather poor in use. An air leakage phenomenon easily occurs during long-term storage, thus affecting the storage effect.

### SUMMARY OF THE UTILITY MODEL

The utility model is directed to design an air valve for an opening of a compression bag, which has a simple and reliable structure and a desirable effect in use so as to solve the defects of the foregoing technologies.

An air valve for an opening of a compression bag designed in the utility model includes an air valve bottom plate fixed at the opening of the compression bag and a silicon pad with a T-shaped cross section. A cylinder is disposed on an upper side surface of the air valve bottom plate. The air valve bottom plate and the cylinder are penetrated through an air vent. A ring sleeve is disposed on an inner sidewall of an upper opening edge of the air vent. A convex ring is disposed on a top surface of the ring sleeve. A lower side surface of a horizontal portion of the silicon pad fits the convex ring. A plurality of support ribs are distributed in an annular array at the periphery of a lower opening edge of the air vent. Ribs are disposed at two corresponding positions of the lower opening edge of the air vent. The ribs and the plurality of support ribs are all disposed on a lower side surface of the air valve bottom plate. A ring is disposed at a central position of the air vent. An end portion of each of the support ribs extends into the air vent to be connected to a lateral portion of the ring. A longitudinal portion of the silicon pad passes through the ring, and a bottom end of the longitudinal portion has a boss with a greater volume than that of the longitudinal portion so as to limit the silicon pad. An air valve cover tightly covers the cylinder, and the horizontal portion of the silicon pad is tightly compressed by the air valve cover.

Further preferably, an upper side of the end portion of the support rib connected to the ring is an inclined surface.

Further preferably, the air valve cover tightly covers the cylinder in such a specific structure that: an external thread collar is provided on the upper side surface of the air valve bottom plate, the external thread collar is located at a position of the cylinder, and an internal thread of the air valve cover is screwed on the air valve cover.

Further preferably, a seal ring is provided on the upper side surface of the air valve bottom plate, the seal ring is located at a foot of the external thread collar, and the bottom of the air valve cover tightly fits the seal ring.

Further preferably, the external thread collar, the cylinder, the ribs, the seal ring, the plurality of support ribs, and the ring are combined to form an integrated structure.

Further preferably, the boss is a trapezoidal boss.

Further preferably, four mounting slots fixed to the opening of the compression bag in a sealing manner are provided on the upper side surface of the air valve bottom plate, and four bumps corresponding to positions of the mounting slots respectively are provided on the lower side surface of the air valve bottom plate.

The air valve for an opening of a compression bag designed in the utility model has a simple and reliable structure, is convenient in machining and assembling, and achieves quick venting. The air valve can discharge air in the compression bag quickly during air exhaust; the sealing performance of sealing the opening of the compression bag is further improved, such that the compression bag has a desirable storage effect.

### BRIEF DESCRIPTION OF THE DRAWINGS

FIG. 1 is a schematic diagram of an overall structure according to Embodiment 1;

FIG. 2 is a first schematic structural diagram of an air valve bottom plate according to Embodiment 1;

FIG. 3 is a second schematic structural diagram of an air valve bottom plate according to Embodiment 1; and

FIG. 4 is a third schematic structural diagram of an air valve bottom plate according to Embodiment 1.

### DETAILED DESCRIPTION

Technical solutions in embodiments of the utility model will be described clearly and completely below with reference to the accompanying drawings in the embodiments of the utility model. Apparently, the described embodiments are merely some, rather than all, of the embodiments of the utility model. Based on the embodiments in the utility model, all other embodiments obtained by those of ordinary skill in the art belong to the protection scope of the utility model.

### Embodiment 1

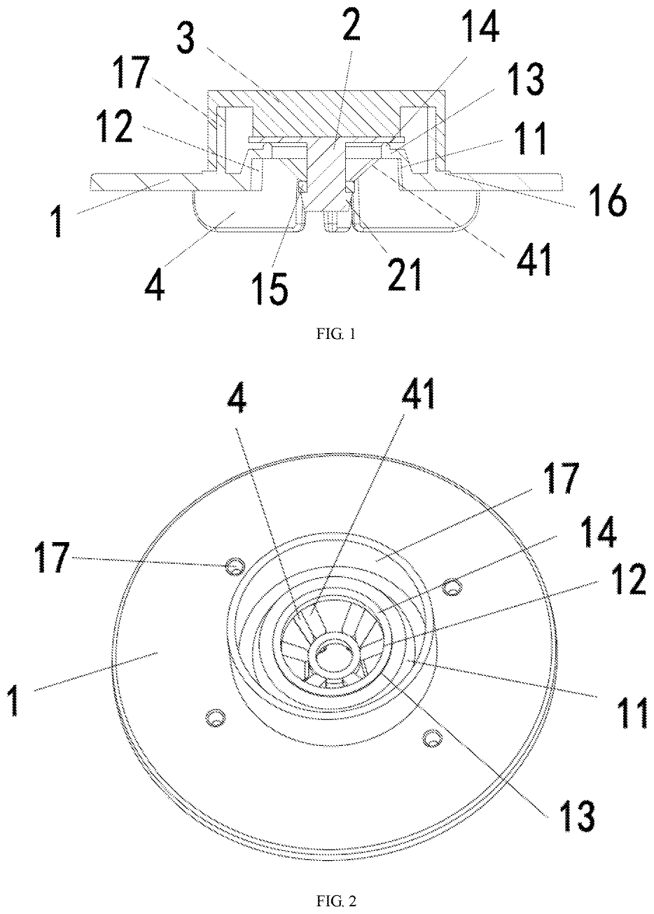

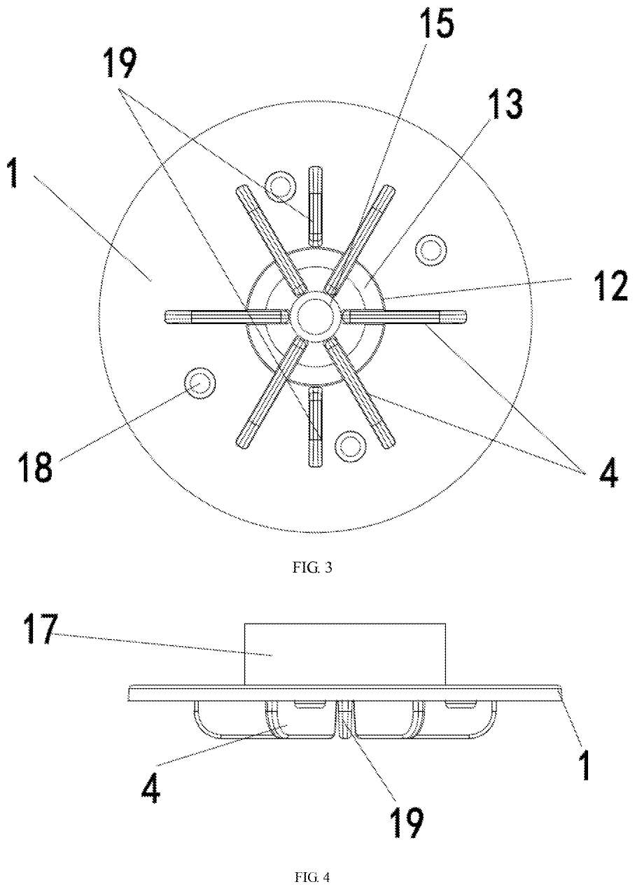

As shown in FIG. 1 to FIG. 4, an air valve for an opening of a compression bag described in this embodiment includes an air valve bottom plate 1 fixed at the opening of the compression bag and a silicon pad 2 with a T-shaped cross section. A cylinder 11 is disposed on an upper side surface of the air valve bottom plate 1. The air valve bottom plate 1 and the cylinder 11 are penetrated through an air vent 12. A ring sleeve 13 is disposed on an inner sidewall of an upper opening edge of the air vent 12. A convex ring 14 is disposed on a top surface of the ring sleeve 13. A lower side surface of a horizontal portion of the silicon pad 2 fits the convex ring 4. A plurality of support ribs 4 are distributed in an annular array at the periphery of a lower opening edge of the air vent 12. Ribs 19 are disposed at two corresponding positions of the lower opening edge of the air vent 12. The ribs 19 and the plurality of support ribs 4 are all disposed on a lower side surface of the air valve bottom plate 1. A ring 15 is disposed at a central position of the air vent 12, and an end portion of each of the support ribs 15 extends into the air vent 12 to be connected to a lateral portion of the ring 15. A longitudinal portion of the silicon pad 2 passes through the ring 14, and a bottom end of the longitudinal portion has a boss 21 with a greater volume than that of the longitudinal portion so as to limit the silicon pad 2. An air valve cover 3 tightly covers the cylinder 11, and the horizontal portion of the silicon pad 2 is tightly compressed by the air valve cover 3. An external thread collar 17, the cylinder 11, the ribs 19, a seal ring 16, the plurality of support ribs 4, and the ring 15 are combined to form an integrated structure. Four mounting slots 17 fixed to the opening of the compression bag in a sealing manner are disposed on the upper side surface of the air valve bottom plate 1, and four bumps 18 corresponding to positions of the mounting slots 17 respectively are disposed on the lower side surface of the air valve bottom plate 1. The bumps 18 enhance the strength of the mounting slots and improve the assembling performance.

Design principles of the foregoing structure are as follows: the pattern design of the ribs 19 and the support ribs 4 on the lower side surface of the air valve bottom plate 1 can reduce abrasion between compression bags, such that the compression bag is more solid and durable and achieves the efficacy of accelerated air exhaust. The air valve bottom plate and the silicon pad both adopt an integrated structure, which can reduce the manufacturing process of the compression bag, increase the working efficiency, and reduce manual works, thus reducing labor costs. After the longitudinal portion of the silicon pad 2 passes through the ring (circular ring) of the air valve bottom plate, the longitudinal portion moves vertically in the ring during air exhaust. The silicon pad 2 always moves flexibly in an air extraction port of an air extractor. Therefore, the structure designed as such increases the air exhaust speed of the air valve. Moreover, a contact surface between the air valve cover 3 and the silicon pad 2 is designed to be wider, thus achieving a better sealing protection function.

In this embodiment, an upper side of the end portion of the support rib 4 connected to the ring 15 is an inclined surface 41. The structure further improves the air exhaust speed of the air valve.

In this embodiment, the air valve cover 3 tightly covers the cylinder 11 in such a specific structure that: the external thread collar 17 is provided on the upper side surface of the air valve bottom plate 1, the external thread collar 17 is located at a position of the cylinder 11, and an internal thread of the air valve cover 3 is screwed on the air valve cover 3. The structure makes the connection of the air valve cover 3 fixed firmly and reliably; the sealing performance is reliable after the air valve cover 3 is mounted, and mounting and detaching are rather convenient.

In this embodiment, the seal ring 16 is provided on the upper side surface of the air valve bottom plate 1. The seal ring 16 is located at a foot of the external thread collar, and the bottom of the air valve cover 3 tightly fits the seal ring 16. The structure improves the sealing performance after the air valve cover is mounted.

In this embodiment, the boss 21 is a trapezoidal boss. The structure enables the longitudinal portion with the boss on the silicon pad to be inserted into the ring more easily.

The utility model is not limited to the foregoing preferred implementation manner, and any person can obtain other products in various forms under the teaching of the utility model. However, any products having technical solutions identical or similar to those of the present application, regardless of any changes in shape or structure, all fall within the protection scope of the utility model.

1. An air valve for an opening of a compression bag, comprising an air valve bottom plate fixed at the opening of the compression bag and a silicon pad with a T-shaped cross section, wherein a cylinder is disposed on an upper side surface of the air valve bottom plate, the air valve bottom plate and the cylinder are penetrated through an air vent, a ring sleeve is disposed on an inner sidewall of an upper opening edge of the air vent, a convex ring is disposed on a top surface of the ring sleeve, and a lower side surface of a horizontal portion of the silicon pad fits the convex ring;
a plurality of support ribs are distributed in an annular array at the periphery of a lower opening edge of the air vent, ribs are disposed at two corresponding positions of the lower opening edge of the air vent, the ribs and the plurality of support ribs are all disposed on a lower side surface of the air valve bottom plate, a ring is disposed at a central position of the air vent, and an end portion of each of the support ribs extends into the air vent to be connected to a lateral portion of the ring; and
a longitudinal portion of the silicon pad passes through the ring, and a bottom end of the longitudinal portion has a boss with a greater volume than that of the longitudinal portion so as to limit the silicon pad; an air valve cover tightly covers the cylinder, and the horizontal portion of the silicon pad is entirely compressed by the air valve cover.

2. The air valve for an opening of a compression bag according to claim 1, wherein an upper side of the end portion of the support rib connected to the ring is an inclined surface.

3. The air valve for an opening of a compression bag according to claim 1, wherein the air valve cover tightly covers the cylinder in such a specific structure that: an external thread collar is provided on the upper side surface of the air valve bottom plate, the external thread collar is located at a position of the cylinder, and an internal thread of the air valve cover is screwed on the air valve cover.

4. The air valve for an opening of a compression bag according to claim 3, wherein a seal ring is provided on the upper side surface of the air valve bottom plate, the seal ring is located at a foot of the external thread collar, and the bottom of the air valve cover tightly fits the seal ring.

5. The air valve for an opening of a compression bag according to claim 4, wherein the external thread collar, the cylinder, the ribs, the seal ring, the plurality of support ribs, and the ring are combined to form an integrated structure.

6. The air valve for an opening of a compression bag according to claim 1, wherein the boss is a trapezoidal boss.

7. The air valve for an opening of a compression bag according to claim 1, wherein four mounting slots fixed to the opening of the compression bag in a sealing manner are provided on the upper side surface of the air valve bottom plate, and four bumps corresponding to positions of the mounting slots respectively are provided on the lower side surface of the air valve bottom plate.
